(19) United States
(12) Patent Application Publication
(10) Pub. No.: US 2012/0187899 A1
(43) Pub. Date: Jul. 26, 2012

(54) POWER SUPPLY SYSTEM, VEHICLE PROVIDED WITH SAME, AND CONTROL METHOD OF POWER SUPPLY SYSTEM

(75) Inventor: Masahito Ozaki, Toyota-shi Aichi-ken (JP)

(73) Assignee: TOYOTA JIDOSHA KABUSHIKI KAISHA, Toyota-shi Aichi-ken (JP)

(21) Appl. No.: 13/356,804

(22) Filed: Jan. 24, 2012

(30) Foreign Application Priority Data
Jan. 25, 2011 (JP) 2011-012844

(51) Int. Cl. H02J 7/00

(52) U.S. Cl. 320/106

(57) ABSTRACT

A power supply system that supplies electric power to a load apparatus includes a power storage device, a voltage sensor, a current sensor, and an ECU. The ECU calculates an internal resistance value of the power storage device based on the detected voltage and the detected current, and determines whether the power storage device includes a power storage device that differs from an authorized power storage device, by comparing the calculated internal resistance value with a preset reference value.

### CROSS REFERENCE TO RELATED APPLICATIONS

This application claims priority to Japanese Patent Application No. 2011-012844 filed on Jan. 25, 2011, which is incorporated herein by reference in its entirety including the specification, drawings and abstract.

### FIELD OF THE INVENTION

The invention relates to a power supply system, a vehicle provided with this power supply system, and a control method of a power supply system. More particularly, the invention relates to control for protecting a power storage device included in a power supply system.

### BACKGROUND OF THE INVENTION

In recent years, vehicles provided with an on-board power storage device (such as a secondary battery or a capacitor) and that run using driving force generated from electric power stored in the power storage device are receiving a lot of attention as environmentally friendly vehicles. These vehicles include, for example, electric vehicles, hybrid vehicles, and fuel cell vehicles and the like.

In such vehicles, charging electric power and discharging electric power of the power storage device must be appropriately controlled in order to prevent damage to or deterioration of the power storage device due to the on-board power storage device being over-charged or over-discharged.

Japanese Patent Application Publication No. 2010-088167 (JP-A-2010-088167) describes technology that, in a vehicle that is able to run by driving force using electric power from a battery, estimates an internal resistance of the battery based on the battery temperature, and sets a limit value of charging-discharging electric power of the battery such that the battery voltage and the battery current each fall within respective predetermined use ranges, based on the estimated internal resistance, the battery voltage, and the battery current.

According to JP-A-2010-088167, abnormal heat generation in the battery that occurs due to excessive charging-discharging of electric power is able to be prevented, while sufficiently displaying charge-discharge performance of the battery and taking into account deterioration of the battery due to heat generation.

In such a vehicle that is able to run using electric power from a power storage device, it is desirable to increase the cruising range from a single charge as much as possible. To accomplish this, there are cases in which the overall charging capacity is increased by connecting other power storage devices in parallel to the power storage device originally provided.

In this case, the protection function for the power storage devices provided in the control system must be modified to match the additional power storage devices. However, if a user adds an unsuitable power storage device on his or her own without modifying the protection function, for example, the protection function may not operate appropriately, and the power storage device and other equipment may deteriorate or be damaged.

### SUMMARY OF THE INVENTION

The invention inhibits deterioration of, or damage to, equipment by detecting whether there is an unsuitable power storage device in a power supply system of a vehicle capable of running using electric power from a power storage device.

A first aspect of the invention relates to a power supply system for supplying electric power to a load apparatus. This power supply system includes a power storage device, a voltage detecting portion, and a control device, and supplies electric power to a load apparatus. The voltage detecting portion detects a voltage of the power storage device. The current detecting portion detects a current supplied to the load apparatus. The control device calculates an internal resistance value of the power storage device based on the detected voltage and the detected current, and determines whether the power storage device includes a second power storage device that differs from an authorized first power storage device, by comparing the calculated internal resistance value with a preset reference value.

In the aspect described above, the control device may set a charging electric power limit value and a discharging electric power limit value for the power storage device, and if the control device determines that the power storage device includes the second power storage device, the control device may set at least one of the charging electric power limit value and the discharging electric power limit value of the power storage device to be lower than when the power storage device is the first power storage device.

In the aspect described above, a switching device that switches between allowing and interrupting a supply of electric power between the power supply system and the load apparatus may be provided in a path that electrically connects the power supply system and the load apparatus together. If the control device determines that the power storage device includes the second power storage device, the control device may control the switching device to interrupt the supply of electric power between the power supply system and the load apparatus.

In the aspect described above, the reference value may be set based on a minimum internal resistance value set from a characteristic of the first power storage device.

In the aspect described above, the control device may determine that the power storage device includes the second power storage device when the calculated internal resistance value is less than the reference value.

A second aspect of the invention relates to a vehicle. This vehicle includes a power supply system, and a driving apparatus that generates driving force for running the vehicle using electric power from the power supply system. The power supply system includes a power storage device, a voltage detecting portion that detects a voltage of the power storage device, a current detecting portion that detects a current supplied to the driving apparatus, and a control device. The control device calculates an internal resistance value of the power storage device based on the detected voltage and the detected current, and determines whether the power storage device includes a second power storage device that differs from an authorized first power storage device, by comparing the calculated internal resistance value with a preset reference value.

A third aspect of the invention relates to a control method of a power supply system that supplies electric power to a load apparatus. The power supply system includes a power storage device, a voltage detecting portion that detects a voltage of the power storage device, and a current detecting portion that detects a current supplied to the load apparatus. The control method includes calculating an internal resistance value of the power storage device based on the detected voltage and the detected current, comparing the calculated internal resistance value with a preset reference value, and determining whether the power storage device includes a second power storage device that differs from an authorized first power storage device, based on the comparison result.

The invention makes it possible to inhibit deterioration of, or damage to, equipment by detecting whether there is an unsuitable power storage device in a power supply system of a vehicle capable of running using electric power from a power storage device.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall block diagram of a vehicle provided with a power supply system according to an example embodiment of the invention;

FIG. 2 is a diagram illustrating a method of detecting that an unsuitable power storage device has been connected, in the example embodiment;

FIG. 3 is a graph showing a change in a calculated internal resistance value, according to whether an unsuitable power storage device is connected;

FIG. 4 is a functional block diagram illustrating battery protection control executed by an ECU, in the example embodiment; and

FIG. 5 is a flowchart illustrating the details of a battery protection control routine executed by the ECU, in the example embodiment.

### DETAILED DESCRIPTION OF EMBODIMENTS

Example embodiments of the invention will be described in greater detail below with reference to the accompanying drawings. Like or corresponding parts in the drawings will be denoted by like reference characters and descriptions of those parts will not be repeated.

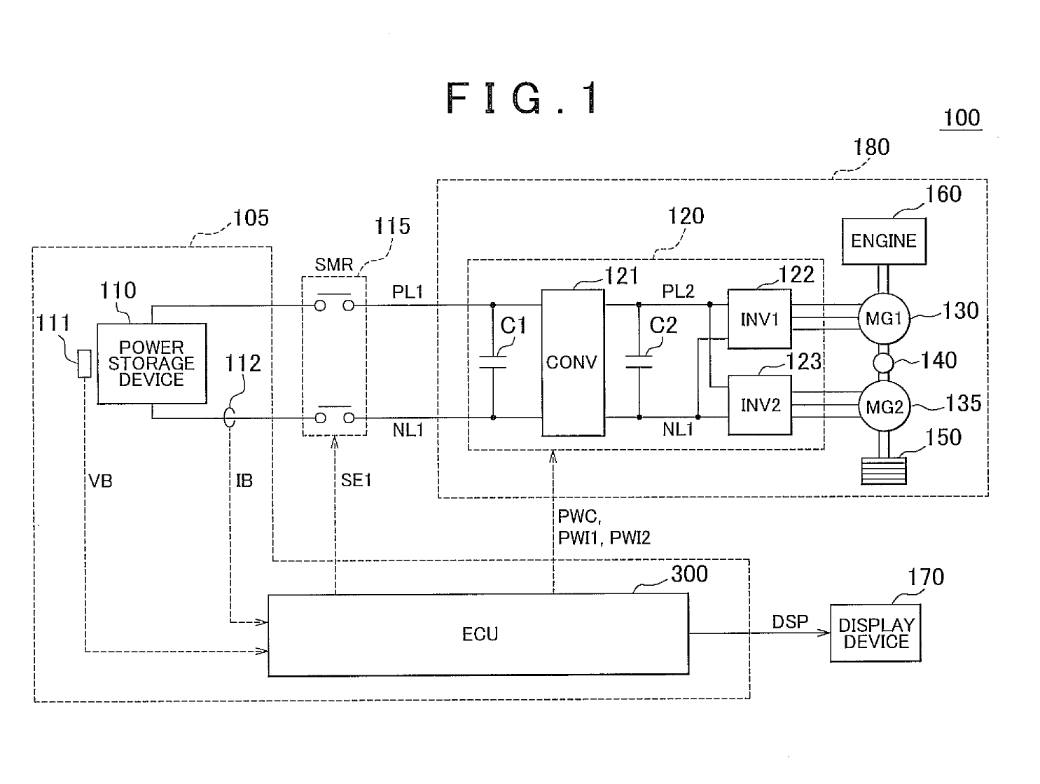

Referring to FIG. 1, a vehicle 100 is provided with a power supply system 105, a System Main Relay (SMR) 115, a display device 170, and a load apparatus 180.

The power supply system 105 includes a power storage device 110, a voltage sensor 111, a current sensor 112, and an Electronic Control Unit (ECU) 300 that is a control device.

The load apparatus 180 includes a Power Control Unit (PCU) 120 that is a driving apparatus, motor-generators 130 and 135, a power transmitting gear 140, driving wheels 150, and an engine 160 that is an internal combustion engine. The PCU 120 includes a converter 121, inverters 122 and 123, and capacitors C1 and C2.

The power storage device 110 is a power storage element capable of being charged and discharged. The power storage device 110 includes, for example, a secondary battery such as a lithium-ion battery, a nickel-metal hydride battery, or a lead battery, or a power storage element such an electric double layer capacitor or the like.

The power storage device 110 is connected to the PCU 120 via a power line PL1 and a ground wire NL1. The power storage device 110 supplies the PCU 120 with electric power for generating driving force for the vehicle 100. The power storage device 110 also stores electric power generated by the motor-generators 130 and 135. The output of the power storage device 110 is approximately 200 V, for example.

The voltage sensor 111 detects a voltage VB of the power storage device 110, and outputs the detection results to the ECU 300. The current sensor 112 detects a current IB input to and output from the power storage device, and outputs the detection result to the ECU 300. In FIG. 1, the current sensor 112 is provided in the ground wire NL1, but it may alternatively be provided in the power line PL1.

Relays in the SMR 115 are provided in the power line PL1 and the ground wire NL1, respectively. The SMR 115 switches between allowing and interrupting a supply of electric power between the power storage device 110 and the PCU 120, based on a control signal SE1 from the ECU 300. The SMR 115 may function as a switching device of the invention.

The converter 121 performs voltage conversion between the power line PL1 and the ground wire NL1, and a power line PL2 and the ground wire NL1, based on a control signal PWC from the ECU 300.

The inverters 122 and 123 are connected in parallel to the power line PL2 and the ground wire NL1, respectively. The inverter 122 converts direct current (DC) electric power supplied from the converter 121 into alternating current (AC) electric power based on a control signal PWI1 from the ECU 300 and drives the motor-generator 130, while the inverter 123 converts direct current (DC) electric power supplied from the converter 121 into alternating current (AC) electric power based on a control signal PWI2 from the ECU 300 and drives the motor-generator 135.

The capacitor C1 is provided between the power line PL1 and the ground wire NL1, and reduces voltage fluctuation between the power line PL1 and the ground wire NL1. Also, the capacitor C2 is provided between the power line PL2 and the ground wire NL1, and reduces voltage fluctuation between the power line PL2 and the ground wire NL1.

The motor-generators 130 and 135 are alternating current (AC) rotary electric machines, such as permanent-magnet synchronous motors that have a rotor with permanent magnets embedded in it.

Output torque of the motor-generators 130 and 135 is transmitted to the driving wheels 150 via the power transmitting gear 140 that includes a reduction gear or a power split device, and is used to drive the vehicle 100. The motor-generators 130 and 135 are able to generate electric power by the rotational force of the driving wheels 150 during a regenerative braking operation of the vehicle 100. Also, this generated electric power is converted by the PCU 120 into charging electric power for the power storage device 110.

Also, the motor-generators 130 and 135 are also connected to the engine 160 via the power transmitting gear 140. The motor-generators 130 and 135 and the engine 160 are operated in coordination with one another by the ECU 300 to generate the necessary vehicle driving force. Moreover, the motor-generators 130 and 135 are able to generate electric power by the rotation of the engine 160, and the power storage device 110 can be charged using this generated electric power. In this example embodiment, the motor-generator 135 is used solely as an electric motor for driving the driving wheels 150, and the motor-generator 130 is used solely as a generator that is driven by the engine 160.

In FIG. 1, a structure in which two motor-generators are provided is shown as an example, but the number of motor-generators is not limited to this. That is, only one motor-generator may be provided, or more than two motor-generates may be provided. Also, the engine 160 is not an essential structure. That is, the vehicle may be an electric vehicle or a fuel cell vehicle in which the engine 160 is not provided. Furthermore, the load connected to the power storage device 110 is not limited to a vehicle such as that described above. That is, this example embodiment may be applied to any electric equipment that is driven by electric power output from the power storage device 110.

The ECU 300 includes a Central Processing Unit (CPU), a storage device, and an input/output buffer, none of which are shown in FIG. 1. This ECU 300 receives signals from various sensors and the like and outputs control signals to various equipment, and controls the power storage device 110 and various equipment of the vehicle 100. Control of these is not limited to processing by software, but may be processing with special hardware (i.e., an electronic circuit).

The ECU 300 calculates the State of Charge (SOC) of the power storage device 110 based on the detection values of the voltage VB and the current IB from the voltage sensor 111 and the current sensor 112 provided with the power storage device 110.

Also, the ECU 300 sets charging-discharging electric power limit values for the power storage device 110 based on the temperature and the SOC and the like of the power storage device 110, and controls the charging-discharging electric power so that it falls within the range of the limit values.

The ECU 300 generates and outputs control signals for controlling the PCU 120 and the SMR 115 and the like. In FIG. 1, a single control device is provided as the ECU 300, but an individual control device may also be provided for each function or each piece of equipment to be controlled, such as a control device for the PCU 120 and a control device for the power storage device 110 and the like.

The display device 170 is a device for visually notifying the user of an abnormality or the state of the vehicle 100, based on a control signal DSP from the ECU 300. The display device 170 may include, for example, a lamp, an LED, or a liquid crystal display panel or the like.

In a vehicle capable of running using electric power from a power storage device, it is desirable to expand the cruising range from a single charge as much as possible. One way to do this is to greatly increase the charging capacity of the power storage device.

In this case, it is possible to replace the authorized power storage device originally provided, with another power storage device that has a larger capacity. However, this is costly, so it may be more practical to increase the overall capacity by simply connecting an additional power storage device in parallel to the authorized power storage device.

However, in the ECU, various parameters for a protection function are typically set matching the specifications of the authorized power storage device originally provided. Therefore, if the user connects an additional power storage device in order to increase the capacity of the power storage device, without changing the parameters for the protection function, the additional power storage device with unknown specifications may be unable to be suitably protected. Furthermore, there is also a possibility that the authorized power storage device originally provided may be over-charged or over-discharged due to effects such as the estimation accuracy in the SOC estimation calculation deteriorating, for example.

Also, even if the capacity of the power storage device does not change, if the user replaces the authorized power storage device with another power storage device having different characteristics, there is a possibility that the protection function will not work appropriately if the parameters for the protection function do not match the replacement power storage device.

Therefore, in this example embodiment, it is determined whether the power storage device that is being used is an authorized power storage device, based on the internal resistance value of the power storage device that is obtained by calculation. If the power storage device is an unauthorized power storage device, battery protection control that limits the charging-discharging electric power more than when the power storage device is an authorized power storage device is executed. As a result, it is possible to prevent problems that may otherwise occur due to a difference between the specifications of the power storage device set in the control device and the specifications of the power storage device that is actually used, if an unsuitable power storage device (in particular, a power storage device with characteristics inferior to those of an authorized power storage device) is connected.

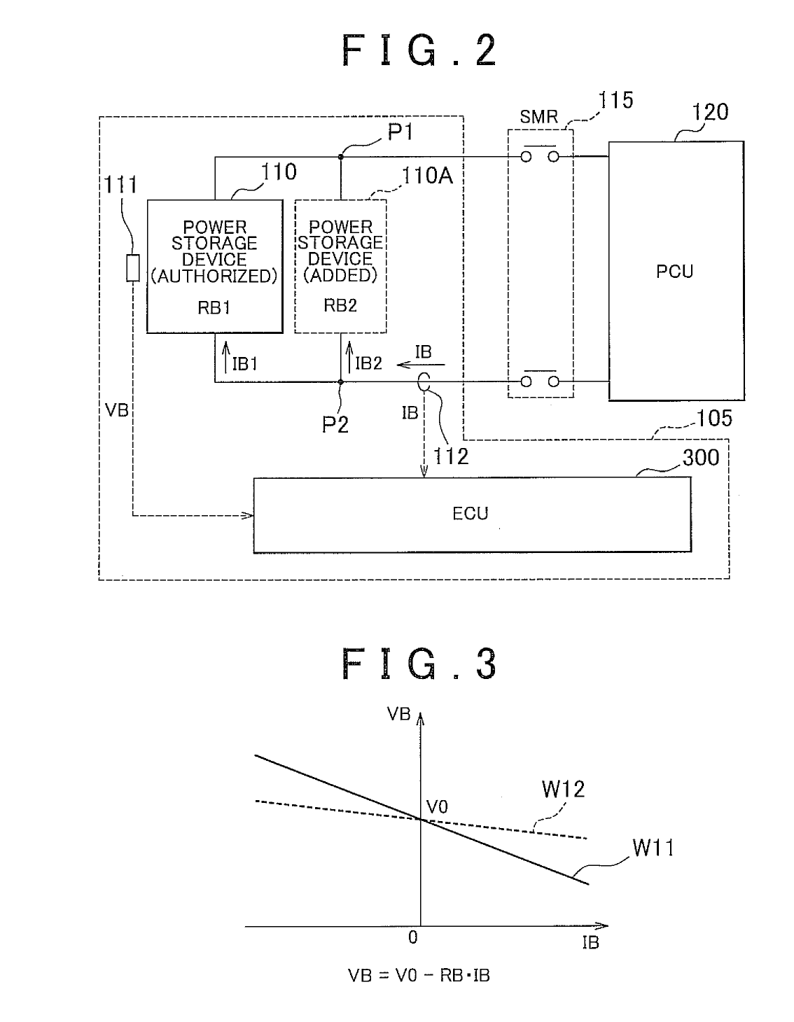

A case in which an additional power storage device 110A that differs from the authorized power storage device 110 originally provided in the power supply system 105 is connected in parallel with the power storage device 110 by the user will now be considered with reference to FIG. 2.

At this time, the current IB detected by the current sensor 112, i.e., the current IB supplied to the load apparatus 180, is the sum of the current IB 1 flowing through the power storage device 110 and the current IB2 flowing through the power storage device 110A (i.e., IB=IB1+IB2).

Here, when the power storage device is singular and the open current voltage (electromotive voltage) of the power storage device is designated V0 and the internal resistance value is designated RB, the expression below is typically satisfied.

VB=V0−RB×IB (1)

However, when the power storage devices 110 and 110A are connected in parallel as shown in FIG. 2, the current that flows to the power storage device 110 is IB1 so if the internal resistance value of the power storage device 110 is designated RB1, the detected voltage VB is as shown by Expression (2) below using Expression (1) above.

VB=V0−RB1×IB1 (2)

Here, IB is greater than IB1 (i.e., IB>IB1), so if the internal resistance value RB1 is the same, the detected voltage VB will be larger than it is when only the power storage device 110 is connected.

However, the current that is detected by the ECU 300 is IB, not IB1, and IB is greater than IB1 (i.e., IB>IB1), so the internal resistance value RB calculated as a result will seemingly be smaller than the original internal resistance value RB1 of the power storage device 110. In other words, the internal resistance value RB obtained from the calculation by the ECU 300 may be equivalent to the combined resistance (RB1×RB2/(RB1+RB2)) of the internal resistance value RB1 of the power storage device 110 and the internal resistance value RB2 of the power storage device 110A. That is, the internal resistance value RB that can be obtained from the calculation by the ECU 300 satisfies Expression (3) below.

VB=V0−IB×{RB1×RB2/(RB1+RB2)} (3)

Therefore, for example, when RB1 equals RB2 (i.e., RB1=RB2), the internal resistance value RB calculated from the voltage VB and the current IB is one half (½) of the actual internal resistance value RB1 of the power storage device 110A, from Expression (3).

FIG. 3 is a graph showing this. The vertical axis in FIG. 3 represents the voltage VB, and the horizontal axis in FIG. 3 represents the current IB. Also in FIG. 3, the straight solid line W11 represents Expression (2), and the straight broken line W12 represents Expression (3). Therefore, the absolute value of the slope of each of these straight lines indicates the internal resistance value RB.

The SOC of the power storage device is known to rely on the voltage VB. Typically, the SOC tends to increase as the voltage VB increases. As shown by the straight broken line W12 in FIG. 3, when the power storage devices 110 and 110A are connected in parallel, and the current IB is positive, i.e., on the discharge side, the detected voltage VB becomes larger that it does when the power storage device 110 is provided by itself (the straight solid line W11), with respect to the detected current IB. That is, it may be determined that the SOC is larger than it actually is. In this case, more electric power than is able to be discharged may end up being output from the power storage devices 110 and 110A, so over-discharging may occur.

On the other hand, when the current IB is negative, i.e., on the charging side, the detected voltage VB becomes smaller than it does when the power storage device 110 is provided by itself, with respect to the detected current IB. Therefore, even if completely charged, it may be determined that charging is still possible, so over-charging may occur.

As described above, if another power storage device is connected in parallel to the power storage device originally provided, an internal resistance that is smaller than the internal resistance value to be calculated when the power storage device is originally connected by itself will be calculated. Therefore, it is possible to detect whether an unsuitable power storage device is connected by comparing the internal resistance value calculated from the calculation with a range of the internal resistance value that can be taken from the characteristics of the power storage device.

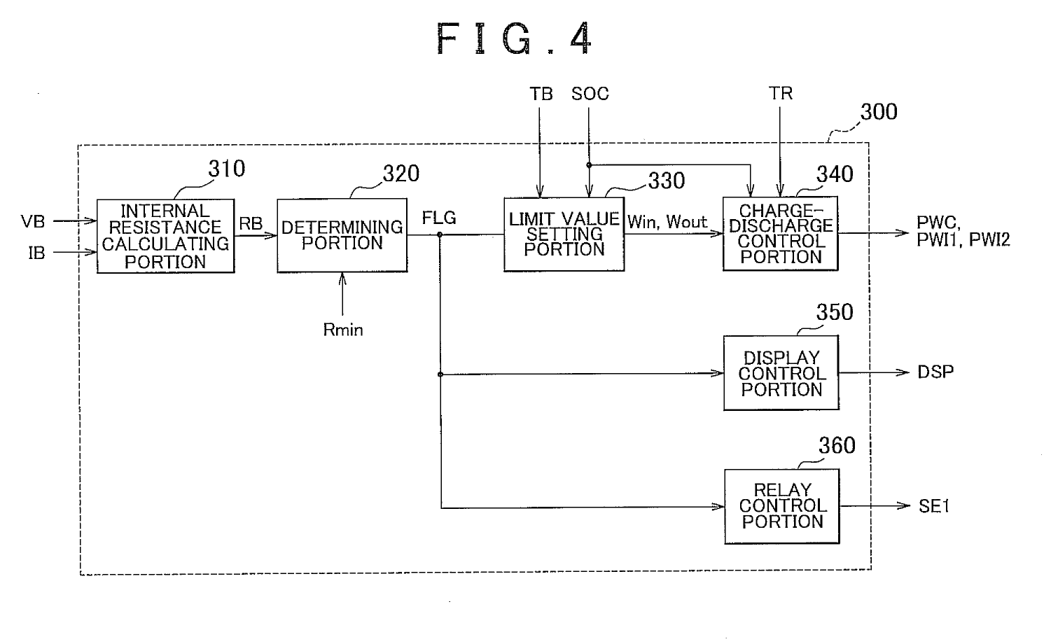

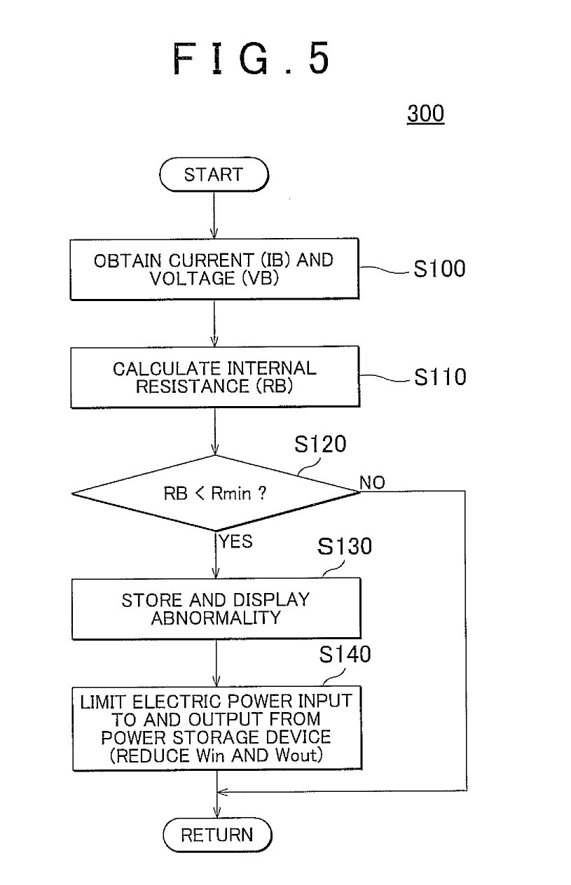

FIG. 4 is a functional block diagram for illustrating battery protection control executed by the ECU 300 in this example embodiment. Each functional block in the functional block diagram of FIG. 4 is realized by a hardware or software process by the ECU 300.

Referring to FIGS. 1 and 4, the ECU 300 includes an internal resistance calculating portion 310, a determining portion 320, a limit value calculating portion 330, a charge-discharge control portion 340, a display control portion 350, and a relay control portion 360.

The internal resistance calculating portion 310 receives the voltage VB of the power storage device 110 detected by the voltage sensor 111, and the current IB (i.e., the current supplied to the load apparatus 180) to be input to and output from the power storage device 110 detected by the current sensor 112. The internal resistance calculating portion 310 calculates the internal resistance value RB of the power storage device 110 using Expression (1), based on the detected voltage VB and current IB, as described with reference to FIG. 3. Then the internal resistance calculating portion 310 outputs the calculated internal resistance value RB to the determining portion 320.

In the calculation of the internal resistance value RB of the power storage device 110, the internal resistance calculating portion 310 may also correct the internal resistance value RB also using the temperature of the power storage device 110 detected by a temperature sensor, not shown.

The determining portion 320 receives the internal resistance value RB of the power storage device 110 calculated by the internal resistance calculating portion 310. The determining portion 320 then determines whether an unsuitable power storage device is connected by comparing the internal resistance value RB to a minimum internal resistance value Rmin set in advance from the characteristics of the power storage device 110 that is a reference value. Then the determining portion 320 prepares a determination flag FLG indicative of the determination result, and outputs it to the limit value calculating portion 330, the display control portion 350, and the relay control portion 360.

The limit value calculating portion 330 receives the temperature TB and the SOC of the power storage device 110, and the determination flag FLG from the determining portion 320. The limit value calculating portion 330 then sets a charging electric power limit value Win and a discharging electric power limit value Wout for the power storage device 110, based on this information. At this time, if the determination flag FLG indicates that an unsuitable power storage device is connected, the limit value calculating portion 330 sets the charging-discharging electric power limit values Win and Wout (i.e., the absolute values thereof) smaller than it does when only the authorized power storage device is connected. This makes it possible to suppress damage to the power storage device and other equipment, or deterioration of the power storage device from being promoted, due to over-charging or over-discharging, if the characteristics of an unsuitable power storage device happen to be inferior to the characteristics of the authorized power storage device.

The charge-discharge control portion 340 receives a torque command value TR for the motor-generators 130 and 135 set based on the SOC of the power storage device 110, the charging-discharging electric power limit values Win and Wout from the limit value calculating portion 330, and an accelerator operation by the user and the like. The charge-discharge control portion 340 generates control signals PWC, PWI1, and PWI2, and controls the converter 121 and the inverters 122 and 123 in the PCU 120, such that the charging-discharging electric power of the power storage device 110 falls within the range of the charging-discharging electric power limit values Win and Wout set by the limit value calculating portion 330.

The display control portion 350 receives the determination flag FLG from the determining portion 320. Then if the determination flag FLG indicates that an unsuitable power supply device is connected, the display control portion 350 outputs a control signal DSP to the display device 170, and notifies the user that there is an abnormality.

The relay control portion 360 receives the determination flag FLG from the determining portion 320. If it would be difficult to protect the power storage device even if the charging-discharging electric power limit values Win and Wout of the power storage device 110 were reduced, the relay control portion 360 outputs a control signal SE1 to interrupt the SMR 115 so that charging and discharging will not be performed by the power storage device.

FIG. 5 is a flowchart illustrating the details of a battery protection control routine executed by the ECU 300, in this example embodiment. The process in the flowchart shown in FIG. 5 is realized by a program stored in advance in the ECU 300 being called up from a main routine and executed at predetermined cycles. Alternatively, the process of some of the steps may also be realized by special hardware (i.e., an electronic circuit).

Referring to FIGS. 1 and 5, the ECU 300 obtains the detection values of the voltage VB from the voltage sensor 111 and the current IB from a current sensor 112 in step S100.

In step S110, the ECU 300 calculates the internal resistance value RB of the power storage device 110 using Expression (1) above.

Then in step S120, the ECU 300 determines whether the calculated internal resistance value RB is less than the minimum internal resistance value Rmin set from the characteristics of the power storage device 110.

If the internal resistance value RB is equal to or greater than the minimum internal resistance value Rmin (i.e., NO in step S120), it is highly likely that the power storage device 110 that is connected is an authorized power storage device, so the process returns to the main routine, and charge-discharge control is executed using the charging-discharging electric power limit values Win and Wout set based on the specifications of the authorized power storage device.

If, on the other hand, the internal resistance value RB is less than the minimum internal resistance value Rmin (i.e., YES in step S120), the process proceeds on to step S130, where the ECU 300 determines that it is highly likely that an unsuitable power storage device is connected, stores information indicative of an abnormality, and displays this information on the display device 170.

Furthermore, in step S140, the ECU 300 sets the charging-discharging electric power limit values Win and Wout of the power storage device to become smaller than the charging-discharging electric power limit values set based on the specifications of the authorized power supply device. As a result, the electric power that can be input to and output from the power storage device is limited. The SMR 115 may also be interrupted in addition to, or instead of, reducing the charging-discharging electric power limit values.

By performing the control according to a process such as that described above, it is possible to suppress deterioration of, or damage to, the power storage device and other equipment due to excessive charging or discharging of electric power, if an unsuitable power storage device that has specifications that differ from those of the authorized power storage device is connected in the power supply system.

In the calculation of the internal resistance value described above, the open circuit voltage V0 in Expression (1) and the like is constant, but in actuality, the open circuit voltage V0 may vary according to the SOC of the power storage device and the like. Therefore, the open circuit voltage V0 used to calculate the internal resistance value may also be made to vary according to the SOC or the like. Alternatively, the open circuit voltage V0 used to calculate the internal resistance value may be a fixed value, and the minimum internal resistance value Rmin that is a reference value may be set taking the fluctuation in the open circuit voltage V0 into account.

Also, in the example description above, the calculated internal resistance value is less than the original internal resistance value due to another power storage device being connected in parallel to the authorized power storage device. On the other hand, if the calculated internal resistance value is much larger than the original internal resistance value, it is highly likely that the connected power storage device is an unauthorized power storage device, or that the connected power storage device is an authorized power storage device that has deteriorated significantly, which may result in damage or the like. Therefore, even if the calculated internal resistance value exceeds the appropriate internal resistance value range, measures may be taken, e.g., charging-discharging electric power limit values such as those described above may be corrected, or the SMR may be interrupted, or the like.

The example embodiments disclosed herein are in all respects merely examples and should in no way be construed as limiting. The scope of the invention is indicated not by the foregoing description but by the scope of the claims for patent, and is intended to include all modifications that are within the scope and meanings equivalent to the scope of the claims for patent.

What is claimed is:

1. A power supply system for supplying electric power to a load apparatus, comprising:
a power storage device;
a voltage detecting portion that detects a voltage of the power storage device;
a current detecting portion that detects a current supplied to the load apparatus; and
a control device that calculates an internal resistance value of the power storage device based on the detected voltage and the detected current, and determines whether the power storage device includes a second power storage device that differs from an authorized first power storage device, by comparing the calculated internal resistance value with a preset reference value.

2. The power supply system according to claim 1, wherein the control device sets a charging electric power limit value and a discharging electric power limit value for the power storage device, and if the control device determines that the power storage device includes the second power storage device, the control device sets at least one of the charging electric power limit value and the discharging electric power limit value of the power storage device to be lower than when the power storage device is the first power storage device.

3. The power supply system according to claim 1, wherein switching device that switches between allowing and interrupting a supply of electric power between the power supply system and the load apparatus is provided in a path that electrically connects the power supply system and the load apparatus together; and if the control device determines that the power storage device includes the second power storage device, the control device controls the switching device to interrupt the supply of electric power between the power supply system and the load apparatus.

4. The power supply system according to claim 1, wherein the reference value is set based on a minimum internal resistance value set from a characteristic of the first power storage device.

5. The power supply system according to claim 1, wherein the control device determines that the power storage device includes the second power storage device when the calculated internal resistance value is less than the reference value.

6. A vehicle comprising:
a power supply system; and
a driving apparatus that generates driving force for running the vehicle using electric power from the power supply system,
wherein the power supply system includes a power storage device, a voltage detecting portion that detects a voltage of the power storage device, a current detecting portion that detects a current supplied to the driving apparatus, and a control device that calculates an internal resistance value of the power storage device based on the detected voltage and the detected current, and determines whether the power storage device includes a second power storage device that differs from an authorized first power storage device, by comparing the calculated internal resistance value with a preset reference value.

7. The vehicle according to claim 6, further comprising a display device that visually notifies a user of an abnormality and a state of the vehicle based on a signal from the control device, wherein if the control device determines that the power storage device includes the second power storage device, the control device outputs a signal to the display device and notifies the user that there is an abnormality.

8. A control method of a power supply system that supplies electric power to a load apparatus and includes a power storage device, a voltage detecting portion that detects a voltage of the power storage device, and a current detecting portion that detects a current supplied to the load apparatus, comprising:
calculating an internal resistance value of the power storage device based on the detected voltage and the detected current;
comparing the calculated internal resistance value with a preset reference value; and
determining whether the power storage device includes a second power storage device that differs from an authorized first power storage device, based on the comparison result.
